(19) United States
(12) Patent Application Publication
(10) Pub. No.: US 2019/0096297 A1
(43) Pub. Date: Mar. 28, 2019

(54) VEHICLE MOUNTED IMAGE PROJECTION SYSTEM

(71) Applicants: Benjamin Cary, Denver, CO (US); Torrey Spink, Denver, CO (US)

(72) Inventors: Benjamin Cary, Denver, CO (US); Torrey Spink, Denver, CO (US)

(21) Appl. No.: 16/147,508

(22) Filed: Sep. 28, 2018

Related U.S. Application Data
(60) Provisional application No. 62/564,262, filed on Sep. 28, 2017.

(51) Int. Cl. G09G 3/00; G06Q 30/02; B60Q 1/50

(52) U.S. Cl. CPC G09G 3/001; G06Q 30/0265; B60Q 1/50; B60Q 2400/50; G09G 2370/16; G09G 2320/10; G09G 2380/10

(57) ABSTRACT

A mobile image projection system includes a wireless network interface configured to communicate with at least one remote computing device and an optical projection device communicatively coupled with the wireless network interface and configured to be mounted on a vehicle and project an image on a surface of a vehicle body. The system includes a processor and a memory configured to store at least one image file and instructions that, when executed, cause the processor to receive, using the wireless network interface an image file from the at least one remote computing device and display an image from the received image file on the surface of the vehicle.

### CROSS REFERENCES TO RELATED APPLICATIONS

This application claims the benefit of U.S. Provisional Application No. 62/564,262 filed on Sep. 28, 2017, the entire contents of which is hereby incorporated by reference.

### BACKGROUND OF THE INVENTION

Current systems for providing custom images on vehicles are limited. For example, vehicles may have decals or wraps applied that include custom images. However, the application of these images may be time consuming and expensive, and the images may be permanent or semi-permanent, limiting the ability of the owner of the vehicle to change images. Some commercial vehicles, such as billboard trucks and buses may have large posters or digital displays applied thereon. These options may be both expensive, and in the case of billboards, may be fairly difficult and/or expensive to replace. Poor return on investment (ROI) and inability to track ROI also issues that arise with traditional advertising mediums.

### BRIEF SUMMARY OF THE INVENTION

Embodiments of the present invention provide techniques for displaying custom images on vehicle bodies using optical image projection mechanisms. Image projection devices in accordance with the present invention are capable of being mounted on a vehicle such that any image may be projected onto a nearby vehicle surface. Images may be received from a remote device using a device interface connection, which may be wired and/or wireless. In some embodiments, the image that is currently projected may be selected on time and/or date information, demographic information of nearby people, location data from the vehicle, and/or other factors. In some embodiments, the images may be changed manually by the user while the car is stationary and/or in motion. The image projection devices described herein provide the ability to change an image displayed on a vehicle at any time, without any additional install/removal costs or time.

In one embodiment, a mobile image projection system is provided. The system may include a wireless network interface configured to communicate with at least one remote computing device and an optical projection device communicatively coupled with the wireless network interface. The optical projection device may be configured to be mounted on a vehicle and to project an image on an exterior surface of a vehicle body. The system may include a processor and a memory configured to store at least one image file and instructions that, when executed, cause the processor to receive, using the wireless network interface an image file from the at least one remote computing device and display an image from the received image file on the exterior surface of the vehicle.

In another embodiment, a mobile image projection system may include a wireless network interface configured to communicate with at least one remote computing device and an optical projection device communicatively coupled with the wireless network interface. The optical projection device may be configured to be mounted on a vehicle and to project an image on an exterior surface of a vehicle body. The system may also include a location module configured to detect a location of the vehicle, a processor, and a memory configured to store at least one image file and instructions that, when executed, cause the processor to determine, using the location module, a current location of the vehicle, select an image based on the current location of the vehicle, and display the image on the exterior surface of the vehicle.

In another embodiment, a method for projecting an image on a vehicle is provided. The method may include receiving, by an optical projection device, an image from a remote device and projecting, by the optical projection device, the image onto an exterior surface of a vehicle while the optical projection device is mounted to the vehicle.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of various components of a projection system according to embodiments.

FIG. 2 depicts a projector generating an image on a hood of a vehicle according to embodiments.

FIG. 3 depicts a projector generating an image on a side of a vehicle according to embodiments.

FIG. 4 depicts a projector according to embodiments of the invention.

FIG. 5 is a system diagram of a projection system and various data sources according to embodiments.

FIG. 6 is a block diagram of a computer system according to embodiments.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present invention are directed to image projection systems that enable a user to project an image onto an exterior surface of a vehicle (such as a car, truck, sport utility vehicle, van, motorcycle, scooter, bicycle, other automobile, watercraft, aircraft, and/or other modes of transportation and/or cargo transport, including, but not limited to, motorized, electric, and/or human powered vehicles). The image projection systems allow users to keep an image on their vehicle for as long as he wants, while providing the ability to easily switch to a new image or no image at will. This is especially useful for users who operate rideshare vehicles, as a particular rideshare companies may not allow their drivers to include certain or any images, and yet the driver may wish to include an image on his vehicle when using the vehicle for personal use. This is particularly useful for users who operate rideshare vehicles, as a particular rideshare company may not allow their drivers to include certain (or any) images. Drivers can turn on and off advertisements and/or other images when picking up a passenger.

Embodiments of the invention also enable mobile imaging systems that allow various images to be displayed on a vehicle. A single image may be displayed at all times that the image projection system is active and/or different images may be displayed based on any number of criteria. For example, images may be selected for display based on a current date and/or time, a location of the vehicle, demographic information of nearby people (based on known people or prior sampling of neighborhood), and/or other factors. This enables, for example, an efficient mechanism for getting advertising content to a desired audience without putting extreme time or cost into installing an advertisement (such as a body wrap or billboard) onto the vehicle.

Embodiments of the present invention may include a projection device that may be mounted to a structure of a vehicle such that the projection device can project images onto an external surface of the vehicle (or screen mounted to an exterior of the vehicle). The image is often projected downward and/or rearward from the projection device, although in some embodiments other orientations of the projected image relative to the projection device are possible. For example, the projection device may be positioned at a bottom and/or rear portion of a vehicle and may project images forward and/or upward onto the exterior of the vehicle. The projection device may (additionally and/or alternatively) be mounted in a manner so as to project images onto a road, a walkway, the ground, a building, and/or other surface. The projection devices described herein may be designed to automatically modify display settings and/or image properties to generate an optimum image based on the angle between the projection device lens and the projection surface, a shape of the projection surface, lighting conditions near the projection surface, color of the projection surface, and/or other variables. For example, a focusing mechanism (such as an ability to adjust the position and/or orientation of one or more internal lenses of the projection device), automatic and/or manual, may enable the projection device to adjust a size, shape, color, brightness, and/or other aspect of the projected image such that the projected image renders as an image on the projection surface having a desired aspect ratio and/or color.

In some embodiments, the image(s) may be projected directly onto an exterior surface of the vehicle, such as a door, hood, window, and/or other vehicle surface. In other embodiments, a display screen may be mounted onto and/or against the exterior of the vehicle. For example, screen hardware may be secured to one or more surfaces of the vehicle using magnetization, clips, other mounting devices, and/or may be custom-built into a surface of the automobile.

In some embodiments, multiple projection devices (and/or a single projection device that can project multiple images at one, such as one using a lenticular lens) may be included on a single automobile, building, and/or other surface. The various projection devices may each project both the same image and/or some or all of the projection devices may project different images at a single time. In some cases, only a subset of the projection devices may be in operation at a single time.

In some embodiments, the projection device and/or other connected device may include software that controls which images are projected and the properties of the image (or how the projection device(s) are to display the image) that is projected. For example, the image file and/or display properties may be modified prior to the image being projected to ensure that the image is displayed properly on the projection surface. For example, if the projection surface is a particular, shape, and/or orientation relative to the projection device, the projection device may alter the image file and/or display characteristics to ensure that the projected image renders with the correct appearance. Such adjustments may be made manually by a user and/or may be done automatically by the projector device sensing the projection surface conditions and automatically adjusting parameters of the image to color to achieve the desired results.

In some embodiments, the projection devices described herein may include location services that allow images to be displayed based on a current location of the vehicle on which the projection device is mounted. The projection devices may also be configured to recognize when to turn on and/or off. As just one example, if an automobile is driving on a highway and is in rightmost lane with no other automobiles and/or other bystanders with visibility to that side of the vehicle, any projection devices on the right side of the vehicle may be disabled to conserve power, preserve operating life of other components, and/or to prevent ads from being displayed without potential and/or sufficient viewers (which may skew metrics and/or cause payment errors for drivers). In some embodiments, simultaneously to disabling the right projection device(s), any projection devices on a left side of the vehicle may be activated as there is a likelihood that bystanders and/or other drivers/passengers would see advertisements on the left side of the automobile. A reverse scenario may exist when a vehicle is in the left most lane. To aid in this functionality, map data may be built in and/or leveraged through other services and/or map applications. The map data may be utilized to determine lane information, walkway locations, traffic information (current and/or historical), pedestrian traffic information, demographic information, notable site data (restaurants, hotels, event centers, schools, other businesses, etc.) and/or other data that may be used to determine when and/or where a particular advertisement is to be displayed.

In some embodiments, the projection devices described herein may be in connectivity with various other devices and software. For example, rideshare application functionality may be integrated into the projection devices such that when passenger is being picked up a name, image, nickname, and/or other identifier of the passenger may be projected on the vehicle. As another example, music streaming applications and/or vehicle radio services may be used in conjunction with the projection devices described herein such that a currently playing song and/or playlist may be displayed on the projection surface. For food or other delivery services, the name of the restaurant and/or other merchant could be displayed. Similarly, a sports application could display real-time stats and/or scores on the projection surface of the automobile, while a weather service may project current weather and or a forecast. In some embodiments, commercials and/or other videos may be displayed using the projection devices described herein.

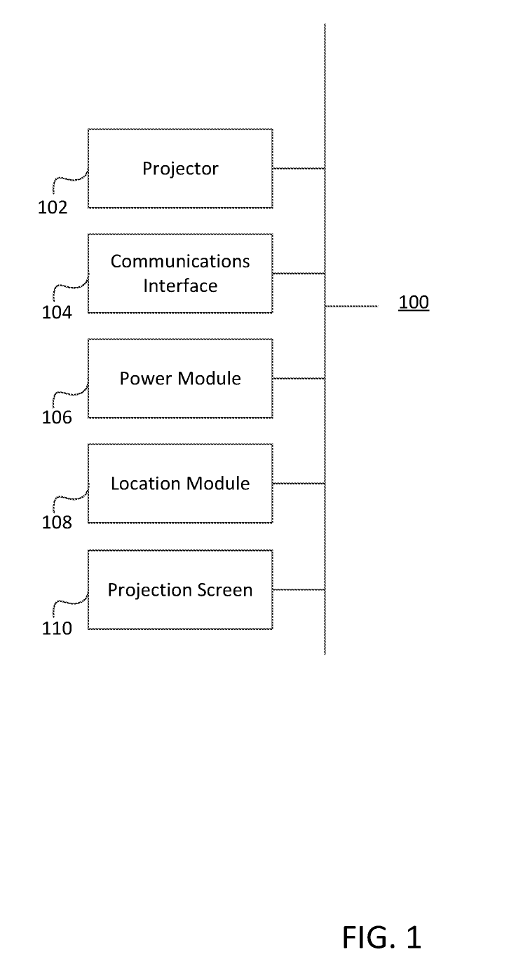

Turning to now FIG. 1, a system diagram of one embodiment of an image projection device 100 is shown. Device 100 may include a projector 102 having at least one lens, at least one light source, and that is configured to project one or more images onto an external surface. Oftentimes, projector 102 is configured to produce a high definition, 4K, and/or other high resolution image. In some embodiments, projector 102 may include a lenticular lens and/or other arrangement of lenses that allows a single projector 102 to produce two distinct images at two different locations. For example, one image may be produced on a first projection surface (or portion thereof) while a second image is produced on a second projection surface (or second portion of the first projection surface). In some embodiments, the projector 102 may be configured to simultaneously produce one image on a projection surface of the vehicle and another image on the ground, wall, and/or nearby structure. It will be appreciated that the multiple images may be the same and/or different in various applications. In some embodiments, the projector 102 may include a specially designed lens system that is configured specifically to project non-distorted images (in the correct aspect ratio, clarity, etc.) at severe angles.

Given the necessarily short distance between the projector 102 and the exterior surfaces of the vehicle, the projector 102 may be a short throw and/or ultra-short throw projector that is capable of projecting images large images from short distances away and at severe angles. For example, projector 102 may be designed to project images exceeding 100 inches from just 0.5-3.5 feet away at angles of between about 10-80 degrees (between the projector 102 and projection surface), although the desired display size of the image may be larger or smaller depending on the image and particular application and/or vehicle (larger vehicles may support larger images as they naturally provide larger projection surfaces). In some embodiments, to facilitate the severe angles, projector 102 may include lens adjustment features, such as lens shift and/or keystone technology. In addition, the projector 102 may has focusable lens(es) that enable sharpens, location, orientation, and/or size adjustments that allow the rendered image to be optimized.

In some embodiments, the lens adjustments and/or other hardware adjustments may be done manually (using mechanical adjustment mechanisms on the projector 102, using a remote and/or attached user interface of the projector 102 to electronically control the projector hardware, and/or using software on a remote device, such as a mobile phone), while in other embodiments, the adjustments may be done automatically by the projector 102. For example, optical sensors built into the projector 102 may detect whether the image is focused and/or at a correct aspect ratio, sharpness, and/or other parameter. Based on the sensor data, the projector 102 may automatically make any necessary adjustments to ensure the image is properly rendered. In some embodiments, each image to be projected may come with preset parameters and/or data that instructs the projector 102 as to the desired final appearance. The projector 102 may then use these instructions to optimize the various components to result in a final image having the desired appearance.

In some embodiments, the adjustments in image parameters may be necessitated by various aspects of the projection surface. For example, the design of the vehicle may alter the distance and/or angle between the projector 102 and the projection surface. As just one example, the projector 102 may be mounted on a side mirror of the vehicle. Larger vehicles, such as trucks, buses, vans, and sport utility vehicles (SUV) may provide larger doors and/or other side surfaces that allow for a more rearward projection surface than a small coupe or hatchback. Similarly, the doors, hoods, and/or other projection surfaces of various vehicles may have different shapes and curvatures, which each require different adjustments to produce an optimal image. Similarly, different vehicle colors may make it more difficult to produce final images having the desired aesthetic properties. Additionally, different lighting conditions (due to time of day/night, shadows, streetlights, car lights, etc.) may require different settings for properly displaying images.

In some embodiments, these variables may be combated by adjusting hardware settings of the projector 102, such as light intensity, lens focus, angle settings, color filters, and/or other component settings of the projector 102. In other embodiments, the image itself may be adjusted to counteract or account for such variables. For example, to account for the angle and distance between the projector 102 and the projection surface (and especially the difference in distance between the projector 102 and a near side of the image and a far side of the image) the image may be distorted or otherwise altered such that it renders properly on the projection surface prior to being displayed. As just one example, the image may be stretched along one or more axes so that it displays in a proper aspect ratio. In the event that the projector 102 is mounted on a side mirror of the vehicle, the front portion of the unaltered image will be closer and narrower than a rear end of the image, which will be stretched out. To counteract this natural distortion, the image file may be altered to stretch the image in an opposite direction, such the altered image has a smaller rear side and a larger front side such that when stretched by the projection angle, the image appears in the proper aspect ratio. The image may also be flipped based on which side of the vehicle the image is to be projected so that the final image appears in a desired orientation. The stretching and/or other distortion of the image may also be done based on a curvature and/or other shape of the projection surface (such as a side, hatchback, door, window, and/or hood of the vehicle).

To account for a color of the projection surface (such as a vehicle body) a color of the image may be adjusted such that when projected on the colored projection surface, the image appears in the intended color. Similarly, as lighting conditions change, a brightness and/or intensity of the image (or light from the projector 102) may be adjusted. In some embodiments, a light sensor may be included on projector 102 that detects the current lighting conditions and adjusts the projector hardware and/or image appropriately, oftentimes in real-time, which may be particularly useful in areas where lighting conditions change constantly.

In some embodiments, the image may be adjusted automatically. For example, the projector 102 may include any number of sensors that are capable of detecting projection angles, distances, shapes and/or colors of projection surfaces, lighting conditions, and/or the like. One or more processors of the projector 102 may adjust the image properties based on some or all of the data. In other embodiments, the images may be adjusted prior to being stored on and/or received by the projector 102. For example, each image may be optimized with image settings for a particular make, model, and/or color of vehicle and/or time of day. A proper image may be selected for display by the projector 102 based on these criteria, minimizing the amount of image processing needed to be done by the processor of the projector 102.

The projector 102 may be configured to produce still images, videos, GIFs, and/or any other type of static and/or dynamic images. For example, still images may include rideshare information. As a rideshare vehicle is about to pick up a passenger, the projector 102 may receive information from the rideshare app and display passenger identifying information (such as a name, nickname, avatar, picture, and/or other identifier of the passenger) on the exterior of the vehicle as the vehicle nears the pickup location. For example, as the vehicle gets within a predetermined distance and/or ETA of the pickup location (such as 1 block and/or 0.1 mile and/or 1 minute and/or other distance and/or time) the information may be displayed. This allows the passenger to more quickly and accurately identify a designated rideshare vehicle, which may be particularly useful in heavily trafficked areas (and may increase the safety of both the passenger and the driver). Once the passenger is picked up, the image may be removed and/or replaced with a different image, such as a rideshare logo and/or advertisement. In other embodiments, the projector 102 may be configured to provide information as to destinations of transit vehicles, such as a final destination of a bus, train, shuttle, and/or other transit vehicle and/or a next stop of the vehicle. Estimated arrival times to each stop/destination may also and/or alternatively be displayed. Airport terminal information and similar information may be projected in some embodiments. Such data helps readily inform potential passengers as to whether the particular vehicle is a good choice for their transit needs. These images (information) may be adjusted as the transit vehicle and/or rideshare vehicle moves.

In other embodiments, the still image may be an image selected by a driver and/or other user of the vehicle. For example, the user may select a logo of a company he likes/endorses (such as a sports team logo or other product logo, an aesthetically pleasing image, such as a landscape painting and/or photo, other trademarked images, custom-made images such as drawings and/or photos, a song title, and/or other images.

Videos, GIFS, and/or other dynamic images may also be displayed using projector 102, although in some embodiments display of such images may be limited to when the vehicle is parked and/or otherwise stationary. Videos may include those from satellite video feeds (projector 102 and/or the vehicle may have a satellite receiver that may be leveraged to received such data) and/or streamed wirelessly. Such streams may include sports highlights, live over the air television and/or Internet feeds, YouTube® clips, and/or other videos. Similarly, scrolling images, such as sports scores, standings, and/or stats, fantasy sports scores and/or standings, new tickers, stock tickers, and/or other scrolling results may be displayed using the projector 102.

In some embodiments, projector 102 may be utilized to display advertisements on one or more exterior surfaces of a vehicle. The advertisements may be static images, videos, GIFs, other dynamic images, and/or combinations thereof. In some embodiments, the ads may just display a logo, location, and/or message from a business, while in other embodiments the ads may include a coupon or discount code. For example, a user viewing the advertisement may photograph and/or otherwise capture an image of the advertisement, which may either provide a coupon or other discount code to the users mobile device and/or the user may show the captured image to a related merchant to receive the discount. In some embodiments, the ad may include a large quick response (QR) code and/or other data tag that the user's mobile device may scan to receive information about the business associated with the ad and/or the coupon and/or other discount code. In some embodiments, information from the user's mobile device, such as location information, timestamps, mobile device identifier (unique device identifier, phone number, and/or other unique identifier) and/or other information may be compared to known locations of the displayed ad to ensure that the user really was present and saw the ad and did not receive the image from a friend or other user. The advertisements may be configured to be displayed at all times and/or based on one or more criteria. For example, the selection of advertisements (or other images) for display may be based on a current location, time, event data, demographic data, weather, and/or other criteria. In some embodiments, the displayed advertisement and/or other image may be automatically changed by the projector 102 to match the current conditions.

The projection device 100 may include a communications interface 104. Communications interface 104 may be configured to send and receive data between the projector 102 and remote devices, such as data services, image sources, advertisers, and the like. For example, the communications interface enables the projector 102 to receive images for display from external devices, such as satellite services, advertisers, mobile devices, image databases, servers, and/or other devices. Additionally, demographic data associated with a particular area may be received from various sources (census data, social media services, and/or other services) that allow advertisements and other images to be selected to match the local population. In some embodiments, relatively short range communications protocols (such as Bluetooth® Low Energy (BLE) may be used to poll nearby mobile devices for demographic information associated with users of the mobile devices. This allows real-time demographic information of the users most likely to see the advertisement and/or other advertisement to be used to drive the image selection. Similarly, data associated with local events (times, locations, demographics of attendees, etc.), weather information, traffic data (real-time and/or historical, and/or other data may be received using the communications interface 104 for use in better selecting advertisements and/or other images for display.

The communications interface 104 may also be utilized for sending data from the projection device 100 to remote devices. For example, location information (provided from a location module 108) and/or local demographic information may be provided to an image source and/or advertiser such that an appropriate image and/or advertisement may be selected for display using the projector 102. Additionally, metrics associated with the display of various images may be provided to an advertiser and/or other third party. For example, a display time/duration information for each image/advertisement, location information for each image/advertisement, any detected views/impressions (which could be detected via short range communications such as BLE and/or using cameras affixed to the vehicle), and/or other data that may be useful in tracking the impact of each image may be sent to the remote source using the communications interface 104.

Communications interface 104 may include any number of wired and/or wireless connections. For example, communications interface may include a Wi-Fi chip and/or other network card, a BLE interface, satellite receiver and/or transceiver, cellular antenna (LTE, 3G, 4G, 5G, etc.), and/or other radio frequency (RF) antennas. In some embodiments, the communications interface 104 may include one or more wired connections. For example, the communications interface 104 may be wired into a vehicle's infotainment system, which allows the projection device 100 to leverage the various functionality of the system. For example, the communications interface 104 may receive song information, GPS data, videos, sports information, news, and/or other information from the infotainment system. Additionally, the communications 104 may leverage the communications antennas of the infotainment system to send and receive data for the projection device 100.

Projection device 100 may interact with one or more image sources to receive and/or retrieve images from for display by the projector 102. In some embodiments, the image source(s) may be remotely located, such as a server, cloud server, advertising system, app store-like image host, and/or other device. For example, an advertiser may have images stored in a database or server that are designated for display under certain conditions (time, location, nearby demographic makeup, etc.). Based on detected conditions, the projection device 100 and/or the remote source may select and download an image from the database and subsequently display the image using projector 102. In some embodiments, the remote storage may be on a user's phone and/or other mobile device or computer. A mobile application, website, or other software may be configured to interface with the communications interface 104 (such as using a local Wi-Fi connection, BLE connection, and/or other wired and/or wireless connection). Users may be able to download and/or otherwise select images from the mobile device and/or from another remote source. These images may be downloaded by the projection device 100 and/or streamed to the projection device 100 for subsequent display by the projector 102. For example, the user may navigate a browser and/or app to an image service or folder on the user device and select an image for projection. The image may be streamed using a BLE or other wireless connection, such as in a mirroring function or background stream that allows the user to continue viewing other content on the user device while the image is streamed to and projected by the projector 102. In embodiments where data is downloaded to the projection device 100 (by a user, advertiser, and/or other third party), the image files and any associated criteria for displaying the image may be stored on a memory device of the projection device 100. For example, the projection device may include a flash memory device and/or a hard disk drive that can store any number of images and/or other data and may be accessed for projecting the images using the projector 102.

The projection device 100 may be attached to a vehicle as an aftermarket retrofit solution and/or may be integrated into the original manufacturing process. For example, the projection device 100 may be secured to a vehicle using one or more clips, fasteners, and/or other securement mechanism. In some embodiments, one or more securement mechanisms may be configured to attach the projection device 100 to the hood or front of a vehicle such that the projector 102 may project images on a hood of the vehicle. In other embodiments, one or more securement mechanisms may be used to clip, fasten, and/or otherwise attach the projection device 100 to a side mirror, door, wheel arch, window, and/or other side component of the vehicle such that the projector 102 may produce an image on a side surface of the vehicle. In other embodiments, the projection device 100 may be mounted on or near a rear of the vehicle such that an image may be projected on a rear surface of the vehicle. Such location may be particularly useful for trucks, SUVs, vans, hatchbacks, and/or other vehicles having large vertical rear surfaces. In some embodiments, rather than being fastened to existing features, the projection device 100 may be integrated into the design of the vehicle body. For example, the projector 102 may be integrated into a hood ornament for projection of images onto the hood and/or built into side mirrors for projection onto side surfaces of the vehicle. For example, the projector 102 may be integrated into the body housing of the side view mirrors and aimed rearward such that the projector 102 is capable of projecting images onto a side surface of the vehicle. In such embodiments, the projector 102 may be positioned in a manner similar to lane change cameras such that the projector 102 is integrated into the design of the vehicle in a relatively seamless manner. Oftentimes, the projector may be positioned underneath and/or outside of the mirror. This allows the mirror to be seen from the interior of the vehicle without interference from any light emitted from the projector 102.

In some embodiments, the projection device 100 may include one or more light shields that are configured to obscure the light source of the projector 102 from the driver and passengers of the vehicle, as well as the driver and/or passengers of other vehicles. For example, on side mirror implementations a shield may extend beyond the lens of the projector 102 that prevent light from being seen from inside the vehicle as well as from behind the vehicle by providing a narrow light path that is focused only on the projection surface. Similarly, in hood mounted embodiments a shield may be provided that prevents light from the projector 102 from being seen from the interior of the vehicle. Similar shields may be provided to limit the visibility of the projected light for projection devices 100 at other locations on the vehicle.

Projection device 100 may include a power module 106 that provides power to the various components of the projection device 100, such as the projector 102, processor, communications interface 104, and/or other electrical components. The power module 106 may include one or more batteries, solar cells, and/or wired power sources. In some embodiments, the power module 106 may include a cigarette lighter adapter, an AC adapter, and/or other power plug that allows the projection device 100 to be powered using the vehicle power system. In other embodiments, the power module 106 may include a transformer and/or adapter that is hard wired into the vehicle's power system, providing an integrated power solution. In some embodiments, the power module 106 may be switched on and off (using a switch or other interface on the projection device 100 and/or wirelessly using a mobile phone or other remote device). In some embodiments, especially those where the power module 106 receives its power from the vehicle power system, the activation of power module 106 may be tied the power status and/or movement of the vehicle.

The projection device 100 may also include a location module 108. Location module 108 enables a location of the vehicle (and projection device 100) to be monitored and tracked, both for metric purposes and to enabled location-based image selection. Location module 108 may include a GPS system that may determine the current location of the projection device 100. In other embodiments, the location module 108 may use the communications interface 104 to leverage the vehicle's GPS system to determine the location of the projection device 100. While discussed primarily as using GPS technology, other location determining systems may be used, such as beacon technology, cellular signal (and/or other RF signal) triangulation, and the like.

Projection device 100 may also include a user interface 108 that allows a user to control various aspects of the projection device 100. For example, the user interface 108 may allow a user to adjust the focus, lens shift, keystone, angle, brightness, intensity, color, and/or other aspect of the projector 102. The user interface 108 may enable the user to adjust various image parameters, such as distortions, colors, and/or other aspects. The user interface 108 may also enable a user to select images for download and/or display using the projector 102. The user interface 108 may include a dedicated display screen that is electronically coupled with the projector 102 and/or may be an external device that is in wireless communication with the projection device 100 via the communications interface 104. As a dedicated display, the user interface 108 may include a graphical user interface (GUI) and at least one input device. The input device(s) may include a touchscreen, keypad, and/or other physical input device. In some embodiment, s the input device may also include a microphone that enables users to provide audio commands to select and/or adjust images for projection, and/or activate/deactivate and/or control various functions of the projection device 100. In other embodiments, a remote device, such as the user's mobile phone, may interface wirelessly (or via a wired connection, such as USB, micro USB, mini USB, USB C, and/or other data connection) with the projection device 100 via the communications interface 104 and be used to control the images and/or projection device 100. For example, the mobile device may execute a mobile application that interfaces with the projection device 104 and provides a GUI that allows the user to control the various aspects of projection device 104. In some embodiments, the user interface 108 may be provided by an infotainment system of the vehicle. When connected to the projection device 100, the infotainment system may be configured to deeply a GUI that allows the user to control the functionality of the projection device 100 via the infotainment system.

In some embodiments, the user may have complete control over what images are shown at all times by using one or more user interfaces 108. In other embodiments, at some or all times the selection and control of images and the projection device 100 may be controlled by a remote device. For example, an advertising source may receive information from the projection device 100 and/or other source (such as current location, event data, nearby merchant data, traffic data, local demographic data, etc.) and determine what image content should be displayed by the projection device 100. The advertising system may then send the content (or a command to display the content if stored locally on the projection device memory device and/or other database. In some embodiments, a number of images may be downloaded onto or may be otherwise accessible by the projection device 100. The advertising system may provide criteria (demographics, location, time, events, etc.) for when each image should be projected by the projection device 100. Upon the criteria being detected by the projection device 100, a corresponding image or images may be selected and projected. Such third party control allows various entities, such as advertisers to choose what people and/or vehicles are associated with their advertisements, which may be done by lists of criteria for each advertisement (such as those described elsewhere herein) and/or that include demographic information and/or vehicle information associated with a driver of the vehicle. In some embodiments, advertisers may also provide whitelists and/or blacklists of vehicles and demographic data (or other criteria) that exclude or make a particular vehicle eligible for a particular advertisement.

In some embodiments, the projection device 100 may include one or more speakers that may be positioned outside of the passenger cabin of the vehicle. These speakers may be mounted next to and/or near the projector 102 on an exterior of the vehicle and enable the projection device 100 to produce audio content that may be associated with the images (including advertisements).

In some embodiments, a projection screen 110 may be included with the projection device 100. The projection screen 110 may provide a uniform surface on which the images may be projected. For example, the projection screen 110 may provide a flat surface that makes it easier to project optimally clear images on the exterior of the vehicle. For example, the projection screen 110 may be a solid color, such as white, and may be secured onto an external surface of the vehicle using clips, a removable adhesive, magnetic connector, and/or other securement mechanism.

It will be appreciated that while discussed as being part of projection device 100, some or all of the components described above may be separate parts of an assembly that are in wired and/or wireless communication with one another. For example, projector 102 may be communicatively coupled with a memory, user interface 108, and/or other components of projection device 100 such that the projector 102 may be mounted outside of a vehicle while the other components are stored within the body of the vehicle. In such embodiments, the housing of the projector 102 may be minimized in size to minimize the space requirements and change in aesthetics to the vehicle associated with the projector 102, while still providing full functionality of the projection device 100 as a whole.

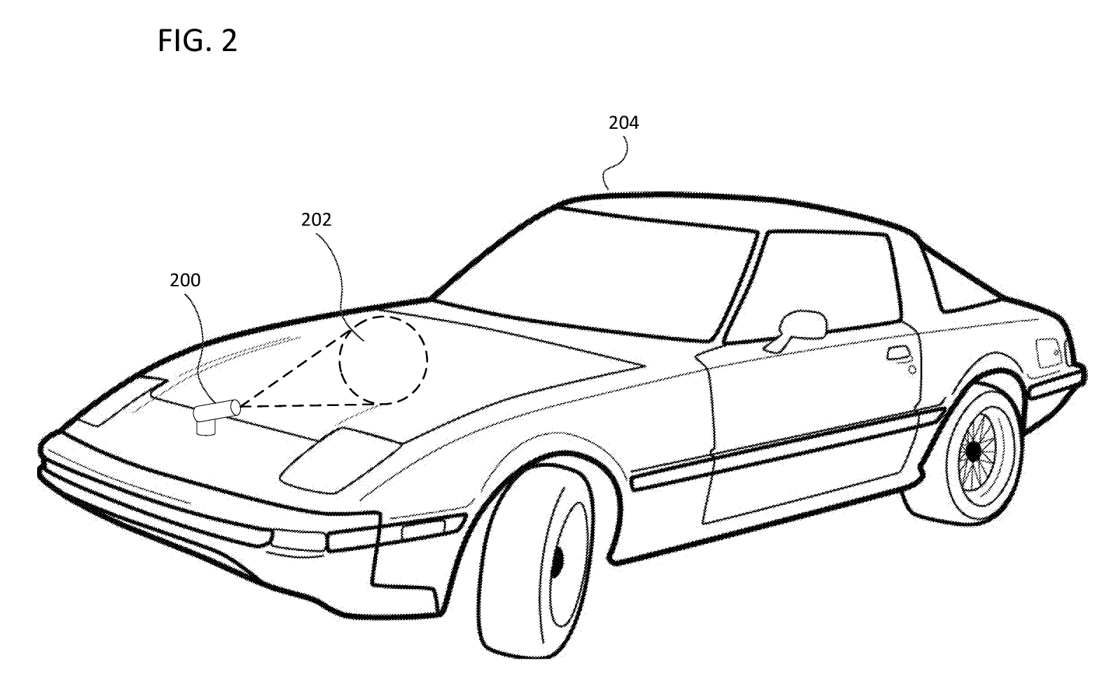

FIG. 2 depicts one embodiment of a projector 200 (similar to projector 102) that is projecting an image 202 on a vehicle 204. As shown here, projector 200 is positioned at or near a position (or in place of) a hood ornament and/or vehicle logo at a front portion of the hood of the vehicle 204. This allows an image to be produced rearward onto a primary surface of the hood. Image 202 may be any size and/or shape, and may include static features, dynamic features, and/or combinations thereof. While shown as being centered at the front of vehicle 204, it will be appreciated that the projector 200 may be mounted on any location on vehicle 204 that allows an image to be projected onto the hood of the vehicle 204. It will be appreciated that projector 200 may include and/or may be coupled with other components similar to those described in relation to the projection device 100.

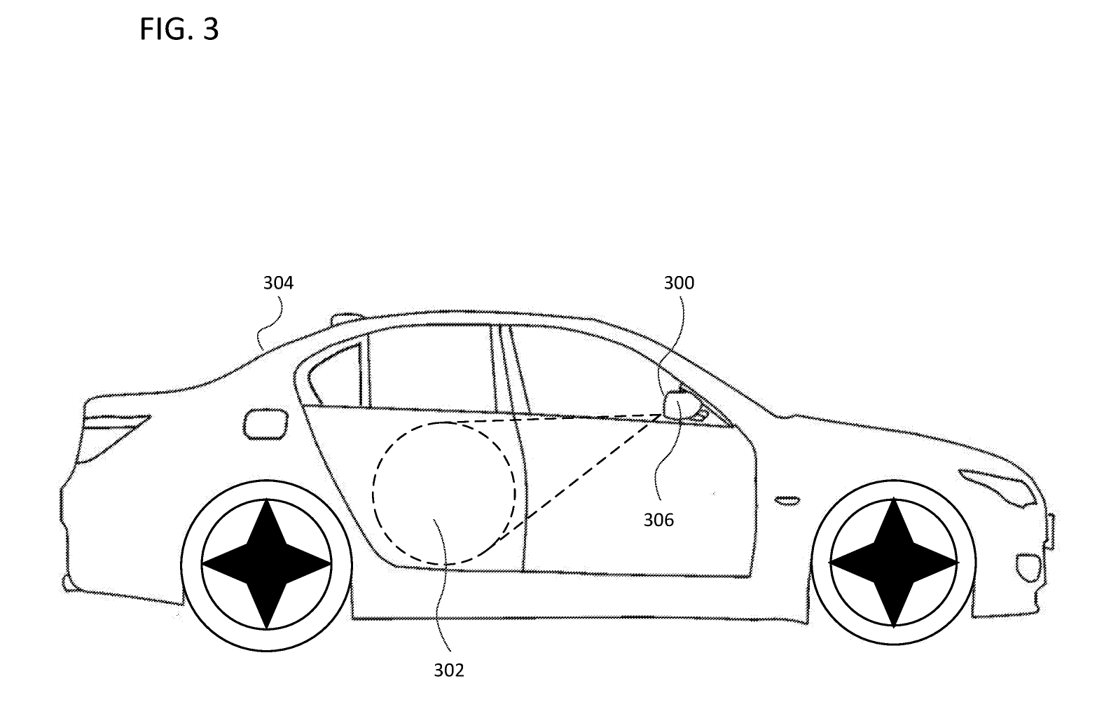

FIG. 3 depicts one embodiment of a projector 300 (similar to projector 102 and projector 200) that is projecting an image 302 on a vehicle 304. As shown here, projector 300 is positioned at or near a position (or in within) a side mirror 306 of the vehicle 304. This allows an image to be produced rearward and/or downward onto a primary side surface (either side) of the vehicle, such as a door and/or window. Image 302 may be any size and/or shape, and may include static features, dynamic features, and/or combinations thereof. While shown as mounted on or in the side mirror 306 of vehicle 304, it will be appreciated that the projector 300 may be mounted on any location on vehicle 304 that allows an image to be projected onto one or more primary side surfaces of the vehicle 304 (and/or the ground or other structure in some embodiments), such as a wheel arch, window, door, and/or other structure of the vehicle 304. It will be appreciated that projector 300 may include and/or may be coupled with other components similar to those described in relation to the projection device 100.

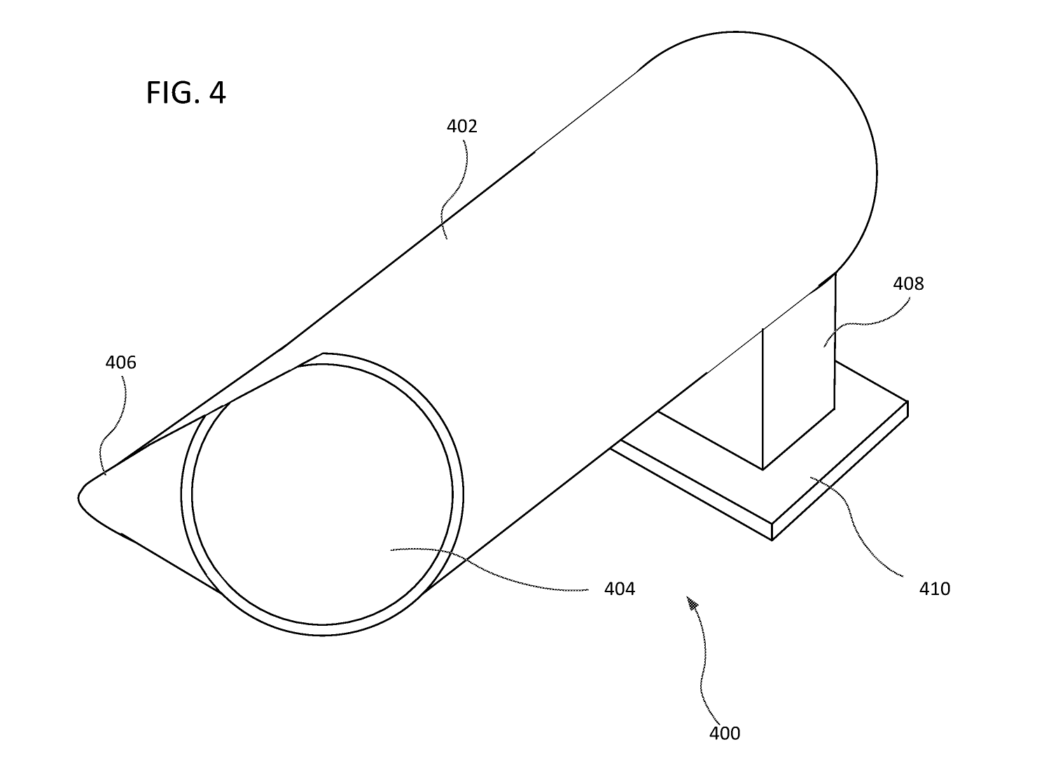

FIG. 4 illustrates a projector 400, similar to projectors 102, 200, and 300. Here, projector 400 includes a housing 402 that surrounds a lens system 404. Lens system 404 is configured to focus an image and light from a light source (not shown) onto a surface of the vehicle and/or other objects. In the present embodiment, projector 400 includes a light shield 406 that may extend around all or part of a light exit of the projector 400. Light shield 406 may be positioned in a manner that allows the light shield 406 to prevent the light from shining directly into the eyes of people who are directly and/or closely aligned with a path of the light being emitted from projector 400. For example, if projector 400 is mounted on a hood of the vehicle and aimed backwards such as shown in FIG. 2, the light shield 406 may extend along a top of the projector to shield the intense light source from being seen above a line that connects the projector 400 with the top/rear side of the image. In embodiments in which the projector 400 is mounted on a side mirror, the light shield 406 may extend along an outer portion of the projector 400 to shield the intense light source from being seen from cars or people positioned behind the vehicle, while still allowing the image itself to be projected on a side of the vehicle.

In some embodiments, the projectors (102, 200, 300, 400) may be built into existing vehicle hardware (such as rear mirror housings). In other embodiments, the projectors may be mounted onto existing hardware using retrofit mounting equipment. For example, one or more fasteners, clamps, magnets, and/or other coupling mechanisms may be provided to secure the projector with a vehicle. For example, as shown in FIG. 4, projector 400 includes a mounting arm 408 that extends from the housing 402 of the projector 400 and is coupled with and/or formed integrally with a mounting flange 410 that may be clipped, clamped, fastened, and/or otherwise secured to one or more structures of the vehicle. Mounting arm 408 may be any length and may be used to extend the projector 400 away from a body of the vehicle to increase the distance between a projection surface and the lens system 404, which may allow the projector 400 to generate a larger image and to decrease the severity of the projection angle. Additionally, in some embodiments, the mounting arm 408 may be adjustable, such as by pivoting, telescoping, and/or otherwise allowing for an angular and/or length adjustment. This ensures that a position of the projector 400 may be adjusted to provide an optimum image on any variety of vehicles. It will be appreciated that while shown with mounting arm 408 and mounting flange 410, any number of mounting mechanisms, both fixed and/or adjustable may be used in accordance with the present invention.

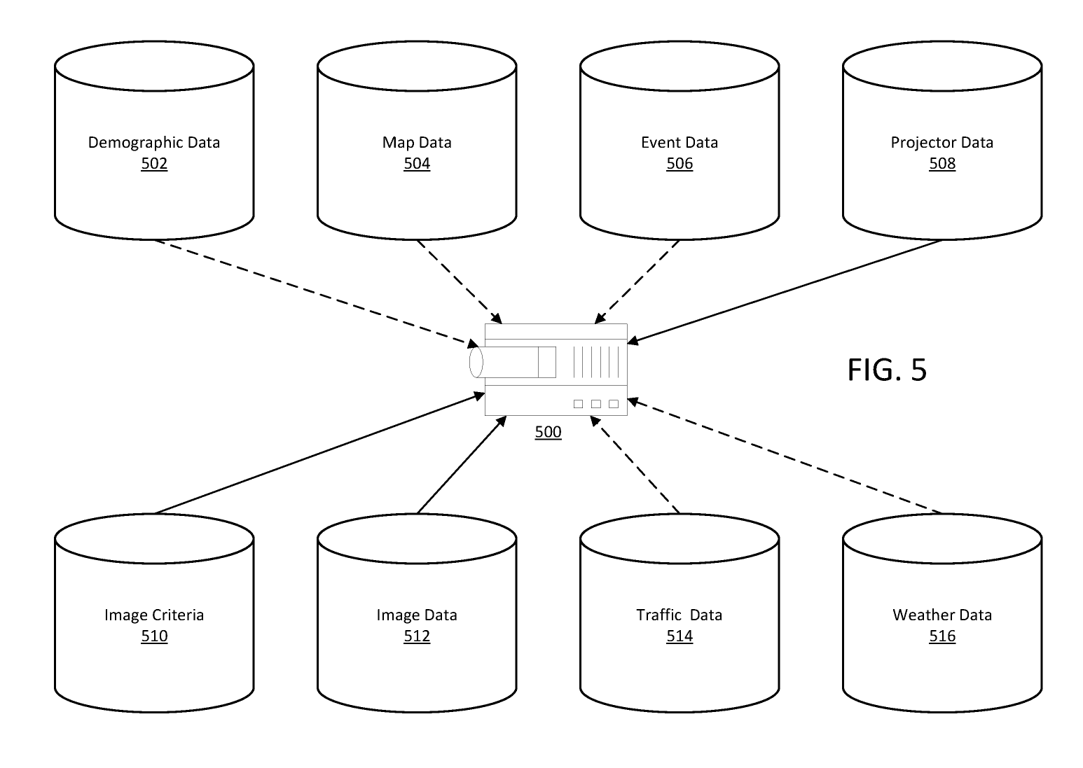

Turning now to FIG. 5, one example of a collection of data stores and/or sources (it will be appreciated that in some embodiments, one or more of the data stores may merely be a source of data and not a database) that may be accessed by a projection device 500, which may be the same or similar to the other projectors/projection devices described herein, in order to determine which images (including advertisements) are to be projected at any given time. Projection device 500 may consult an image criteria data store 510. Image criteria data store 510 may be a local (attached) database that includes rules and other criteria associated with a number of image files. To determine which criteria are currently met, and thus which image to project, projection device 500 may access any number of other data stores. For example, a projector data store 508 may be accessed that provides information related to current conditions of the projection device 500, such as a current date, time, location, and the like. This information may be tracked by components of the projection device 500, such as internal clocks and/or GPS systems, while in some embodiments, external connected devices (such as cellular phones, infotainment systems, tablet computers, and the like) may be polled for such information.

Similarly, a demographic data store 502 may provide information related to the age, gender, ethnicity, socio-economic status, and/or other demographic data for a particular population. When used in conjunction with location data of the projector data store 508, a picture of nearby demographics may be ascertained. In some embodiments, real-time demographic information may be acquired, such as by gathering data from mobile devices that may be connectable to a communications interface of the projection device 500 and may be able to send demographic information associated with the users of the nearby devices.

A map data store 504 may be used in conjunction with the current location of the projection device 500 to determine what merchants, hotels, restaurants, and/or other points of interest may be nearby the projector. Event data store 506 may provide information associated with upcoming and/or ongoing events, including times, dates, sizes, demographic information associated with attendees or expected attendees of such events, locations of events, and/or other relevant data. Traffic data store 514 may provide current and/or historical traffic data near an area of the projection device 500, while the weather data store 516 may be configured to provide current weather and/or weather forecast data.

Projection device 500 may access data from any number and/or combination of these data sources and/or other data sources and compare the current data with image criteria data store 510 to identify a proper image to display at a given time. The image criteria data store 510 may instruct the projection device 500 to retrieve a particular image, which may be retrieved from an image data store 512 and then projected by projection device 500. In some embodiments, this may be done by the image criteria data store 510 revealing an index reference that may be used to lookup a proper image from the image data store 512, while in other embodiments, the image criteria may be data tags that are stored as part of, or associated with, the images themselves. Image data store 512 may be a local memory of the projection device 500 and/or may be remotely located, such as on an advertising platform.

Each of the data stores disclosed may be used as selection criteria for image selection. For example, demographic information for a particular area may be used to select an image (such as an advertisement) that is expected to have a greatest impact on a particular demographic subset. Map data may be used to select an advertisement for a nearby business, event data may be used to select an advertisement to buy tickets to a particular event, such as a concert, sporting event, etc. In times of heavy traffic, advertisements for public transit may be selected, and if the weather is particularly hot or cold weather an advertisement for a coffee shop and/or ice cream shop may be selected.

Any number and combination of variables may be used as criteria for selecting a particular image for projection, with some images having very complex criteria requirements, while others may be simple and merely specify one or two criteria, such as a time and/or location in which the advertisement or other image is to be selected. In some embodiments, each selection criterion must be met in order to display a particular image, while in other embodiments only a subset of criteria may be needed to match. In some embodiments, if no images match the create entirely, a best match may be selected, while in other embodiments, if there is no complete match, the projection device 500 may shut itself down, go into an inactive/low power state, and/or otherwise stop projecting images until a complete match occurs. The selection criteria may be set by a third party, such as an advertiser and/or owner of a particular trademarked image, while in some embodiments the owner and/or user of the projection device 500 may set the criteria using a user interface of the projection device 500. Such functionality may be useful as a user may essentially set up a slideshow of images based on any desired criteria.

While described here as the selection of images based on criteria being performed by projection device 500, it will be appreciated that in other embodiments a third party, such as an advertising source, may make the determinations rather than providing rules for the projection device 500 to follow. For example, a third party device may access the same, similar, and/or different data stores to identify current conditions around the projection device 500 such that the third party device may match the current conditions with image criteria. The third party device may then send commands over a network (and/or the images themselves) to the projection device 500 for subsequent retrieval and display of the selected image(s).

In some embodiments, metrics associated with displayed advertisements may be collected and provided to advertisers. For example, total duration and exact times that a particular ad and/or series of ads were live may be determined. Similarly, locations that each advertisement is displayed may be monitored, a detected and/or estimated population density and/or approximate viewers (impressions) may be tracked, as well as traffic intensity models. It will be appreciated that any other metric and/or combination of metrics may be tracked based on the needs of the advertisers and/or other parties.

In some embodiments, similar projection technology may be usable to project images on other surfaces. For example, projection devices such as those described herein may be mounted in or out of vehicles and aimed downward and/or outward to project images on other surfaces. As just one example, images may be projected onto walls and/or other structures and/or onto the ground where passersby may view the images. In some embodiments, the vehicle may be a bicycle, scooter, electric scooter, gas powered scooter, motorcycle, and/or other vehicle that may include a projection device that may project images on the ground, wall, and/or other structures. In other embodiments, projection devices may be mounted inside of mass transit vehicles, such as planes, buses, trains, boats, and the like. The projection devices may produce images on the interior walls and/or floors of the vehicles, which may provide effective, adaptable ad space.

In some embodiments, a projection device may be mounted such that the projector may display a license plate number at a location of the license plate, which may be particularly useful in aiding law enforcement personal and/or other people identify vehicles in low light settings. In such embodiments, the activation of the projector and/or image may be tied to the operation of the vehicle and may not be disabled.

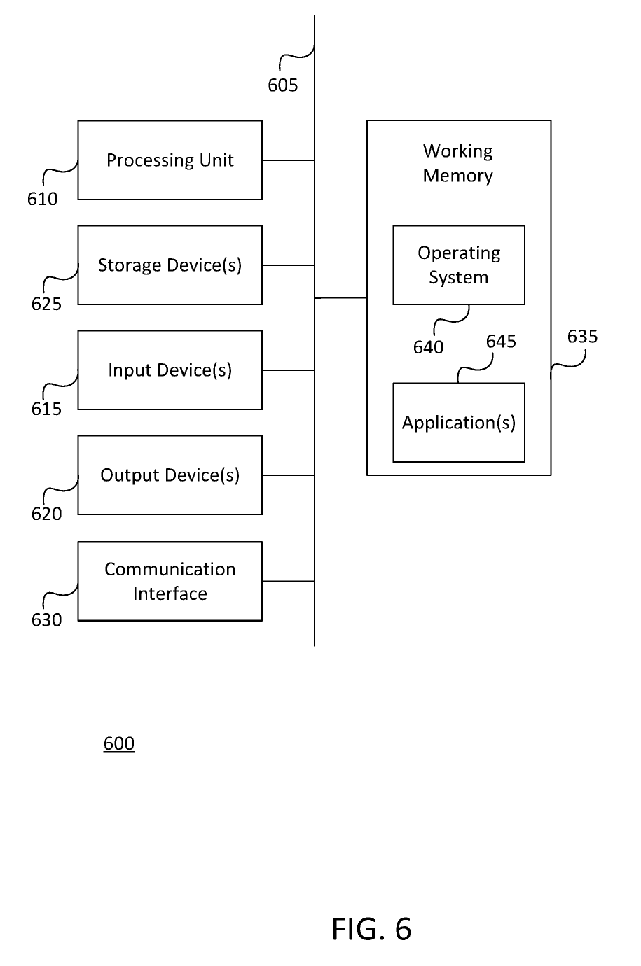

A computer system as illustrated in FIG. 6 may be incorporated as part of the previously described computerized devices. For example, computer system 600 can represent some of the components of the various projectors/projection devices, and the like described herein. FIG. 6 provides a schematic illustration of one embodiment of a computer system 600 that can perform the methods provided by various other embodiments, as described herein. FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements may include a processing unit 610, including without limitation one or more processors, such as one or more special-purpose processors (such as digital signal processing chips, graphics acceleration processors, and/or the like) and which may be specifically designed to handle the image processing and projector hardware adjustment features of the present invention; one or more input devices 615, which can include without limitation a keyboard, a touchscreen, receiver, a motion sensor, a camera, a smartcard reader, a contactless media reader, and/or the like; and one or more output devices 620, which can include without limitation a display device, a speaker, a printer, a writing module, and/or the like.

The computer system 600 may further include (and/or be in communication with) one or more non-transitory storage devices 625, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 600 might also include a communication interface 630, which can include without limitation a modem, a network card (wireless or wired), an infrared communication device, a wireless communication device and/or chipset (such as a Bluetooth™ device, an 502.11 device, a Wi-Fi device, a WiMAX device, an NFC device, cellular communication facilities, etc.), and/or similar communication interfaces. The communication interface 630 may permit data to be exchanged with a network (such as the network described below, to name one example), other computer systems, and/or any other devices described herein. In many embodiments, the computer system 600 will further comprise a non-transitory working memory 635, which can include a RAM or ROM device, as described above.

The computer system 600 also can comprise software elements, shown as being currently located within the working memory 635, including an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such special/specific purpose code and/or instructions can be used to configure and/or adapt a computing device to a special purpose computer that is configured to perform one or more operations in accordance with the described methods.

A set of these instructions and/or code might be stored on a computer-readable storage medium, such as the storage device(s) 625 described above. In some cases, the storage medium might be incorporated within a computer system, such as computer system 600. In other embodiments, the storage medium might be separate from a computer system (e.g., a removable medium, such as a compact disc), and/or provided in an installation package, such that the storage medium can be used to program, configure and/or adapt a special purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, a risk management engine configured to provide some or all of the features described herein relating to the risk profiling and/or distribution can comprise hardware and/or software that is specialized (e.g., an application-specific integrated circuit (ASIC), a software method, etc.) or generic (e.g., processing unit 610, applications 645, etc.) Further, connection to other computing devices such as network input/output devices may be employed.

Some embodiments may employ a computer system (such as the computer system 600) to perform methods in accordance with the disclosure. For example, some or all of the procedures of the described methods may be performed by the computer system 600 in response to processing unit 610 executing one or more sequences of one or more instructions (which might be incorporated into the operating system 640 and/or other code, such as an application program 645) contained in the working memory 635. Such instructions may be read into the working memory 635 from another computer-readable medium, such as one or more of the storage device(s) 625. Merely by way of example, execution of the sequences of instructions contained in the working memory 635 might cause the processing unit 610 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 600, various computer-readable media might be involved in providing instructions/code to processing unit 610 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 625. Volatile media include, without limitation, dynamic memory, such as the working memory 635. Transmission media include, without limitation, coaxial cables, copper wire, and fiber optics, including the wires that comprise the bus 605, as well as the various components of the communication interface 630 (and/or the media by which the communication interface 630 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a magnetic medium, optical medium, or any other physical medium with patterns of holes, a RAM, a PROM, EPROM, a FLASH-EPROM, any other memory chip or cartridge, a carrier wave as described hereinafter, or any other medium from which a computer can read instructions and/or code.

The communication interface 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a non-transitory storage device 625 either before or after execution by the processing unit 610.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

What is claimed is:

1. A mobile image projection system, comprising:
a wireless network interface configured to communicate with at least one remote computing device;
an optical projection device communicatively coupled with the wireless network interface and configured to:
be mounted on a vehicle; and
project an image on an exterior surface of a vehicle body;
a processor; and
a memory configured to store at least one image file and instructions that, when executed, cause the processor to:
receive, using the wireless network interface an image file from the at least one remote computing device; and
display an image from the received image file on the exterior surface of the vehicle.

2. The mobile image projection system of claim 1, further comprising:
a location module configured to detect a location of the vehicle, wherein the image is displayed based on the location of the vehicle.

3. The mobile image projection system of claim 1, further comprising:
a mounting device configured to mount to an existing feature of the vehicle body.

4. The mobile image projection system of claim 1, wherein:
the mobile image projection system is built into the vehicle body.

5. The mobile image projection system of claim 1, wherein:
the exterior surface comprises a door or hood of the vehicle.

6. The mobile image projection system of claim 1, wherein:
optical properties of the projected image are based on one or more of a make and model of the vehicle, a color of the vehicle, or a relative position of the mobile image projection with respect to the surface of the vehicle body.

7. The mobile image projection system of claim 1, wherein the instructions further cause the processor to:
distort the image prior to displaying the image based on an angle between the optical projection device and the surface.

8. A mobile image projection system, comprising:
a wireless network interface configured to communicate with at least one remote computing device;
an optical projection device communicatively coupled with the wireless network interface and configured to:
be mounted on a vehicle; and
project an image on an exterior surface of a vehicle body;
a location module configured to detect a location of the vehicle;
a processor; and
a memory configured to store at least one image file and instructions that, when executed, cause the processor to:
determine, using the location module, a current location of the vehicle;
select an image based on the current location of the vehicle; and
display the image on the exterior surface of the vehicle.

9. The mobile image projection system of claim 8, wherein:
the image is selected from a plurality of images stored on the memory.

10. The mobile image projection system of claim 8, wherein the instructions further cause the processor to:
send the location of the vehicle to a remote source; and
receive the selected image from the remote source.

11. The mobile image projection system of claim 8, wherein:
the image is provided by a computer system of the vehicle or a wireless mobile device.

12. The mobile image projection system of claim 8, further comprising:
a display screen configured to present a graphical user interface that provides control of the optical projection device.

13. The mobile image projection system of claim 8, wherein the instructions further cause the processor to:
determine demographic information of a population of people proximate the vehicle, wherein the image is further selected based at least in part on the demographic information.

14. A method for projecting an image on a vehicle, the method comprising:
receiving, by an optical projection device, an image from a remote device; and
projecting, by the optical projection device, the image onto an exterior surface of a vehicle while the optical projection device is mounted to the vehicle.

15. The method for projecting an image on a vehicle of claim 14, further comprising:
detecting an angle between the optical projection device and the exterior surface of the vehicle; and
adjusting one or both of a lens of the optical projection device or the image based on the angle.

16. The method for projecting an image on a vehicle of claim 14, further comprising:
detecting a lighting condition at the exterior surface of the vehicle; and
adjusting one or both of a lens of the optical projection device or the image based on the lighting condition.

17. The method for projecting an image on a vehicle of claim 14, further comprising:
detecting a shape of the exterior surface; and
adjusting one or both of a lens of the optical projection device or the image based on the shape.

18. The method for projecting an image on a vehicle of claim 14, further comprising:
detecting a color of the exterior surface; and
adjusting one or both of a lens of the optical projection device or the image based on the color.

19. The method for projecting an image on a vehicle of claim 14, further comprising:
mounting the image projection system on the vehicle.

20. The method for projecting an image on a vehicle of claim 14, wherein:
the image is selected from a plurality of images based at least in part on one or both of a current time of day or a current location of the vehicle.
